(19) United States
(12) Patent Application Publication
(10) Pub. No.: US 2013/0109580 A1
(43) Pub. Date: May 2, 2013

(54) High-Affinity Peptide Probes for Tumor Biomarker, GRP-78, and Screening Method Thereof

(71) Applicants: Chia-Hung Huang, Taoyuan County (TW); Shui-Cheng Lee, Taoyuan County (TW); Pei-Tzu Ku, Taoyuan County (TW); Ker-Jer Huang, Taoyuan County (TW)

(72) Inventors: Chia-Hung Huang, Taoyuan County (TW); Shui-Cheng Lee, Taoyuan County (TW); Pei-Tzu Ku, Taoyuan County (TW); Ker-Jer Huang, Taoyuan County (TW)

(73) Assignee: ATOMIC ENERGY CONCIL-INSTITUTE OF NUCLEAR ENERGY RESEARCH, Taoyuan County (TW)

(21) Appl. No.: 13/283,704

(22) Filed: Oct. 28, 2011

(51) Int. Cl. C40B 30/04; C40B 40/10

(52) U.S. Cl. 506/9; 506/18

(57) ABSTRACT

Peptide ligands are found. All of the peptide ligands have high-affinity against a tumor biomarker, GRP-78. Phage display library is used for screening out the peptide ligands. The peptide ligands can be labeled with a luminescent or a radioactive material to be used as probes for detecting tumor.

### TECHNICAL FIELD OF THE INVENTION

The present invention relates to peptides against tumor biomarker; more particularly, relates to screening out high-affinity peptide ligands against a tumor biomarker, GRP-78.

### DESCRIPTION OF THE RELATED ARTS

Phage is bacterial virus, which grows fast but does not infect human. Hence, it is widely applied in many fields. General phages include T7, lambda and M13.

Most phages have two types of life cycle after infecting bacteria and the two types are exchangeable: one is lysogenic cycle and the other is lytic cycle. In the lysogenic cycle, DNA of the phage is inserted into DNA of a cell. During the lysogenic cycle, the phages are latened in the bacteria without amplification and almost do not harm the bacteria. In the lytic cycle, DNAs of the phages are continuously amplified and show gene expression. Although phages grow in number, the bacteria may grow slow or even die. The phage applied for phage display is usually M13 phage. M13 is a filamentous bacteriophage having a diameter about 9 nanometers (nm) and a length about 900 nm. DNA of M13 phage is coated with g8 protein (g8p) 51 and is bound to bacterial pilus by using g3 protein (g3p) 52 for infection. A company, New England Biolab (NEB), uses the phage for gene recombination. As shown in FIG. 6, N-terminus of g3p is added with 7 random combined amino acids having a sequence named as X1-X7 to form a large database. The database has about 1.28×109 sequences, which are obtained from the positions for expressing different peptides of phage display library of Ph.D-7. For convenience, NEB also makes the phage express β-galactosidase, coordinated with a bacterium having tetracycline yet in lack of β-galactosidase. If only the bacterium is amplified, a Luria-Bertani (LB) broth can be added with tetracycline. If the phage is required to be quantified, the phage and the bacterium are mixed and then are cultured in the LB agar medium with X-Gal 61. The bacterium 63 infected by the phage 62 is resolved with X-Gal to make plaque 64 become blue in color. As shown in FIG. 7, if the bacterium is contaminated, it is not easy to grow the bacterium in the culture medium having tetracycline. If the phage is contaminated, a color of the plaque 65 should be yellow or even transparent.

The database contains all possible amino acid sequences. Hence, all amino acid sequences used in protein-protein interaction are contained in the database. NEB suggests that any material capable of binding to protein can find affinitive amino acid sequence in the database if the material has consensus smaller than 7 amino acids. Although amino acid sequences processed through post-translation modification cannot be found, the database is still widely used. It is used for epitope mapping in immunology (Youn, J. H. et al. Production and characterization of peptide mimotopes of phenolic glycolipid-I of Mycobacterium leprae. FEMS Immunol Med Microbiol 41, 51-7 (2004); Spillner, E., Deckers, S., Grunwald, T. & Bredehorst, R. Paratope-based protein identification by antibody and peptide phage display. Anal Biochem 321, 96-104 (2003); and, Rowley, M. J. et al. Prediction of the immunodominant epitope of the pyruvate dehydrogenase complex E2 in primary biliary cirrhosis using phage display. J Immunol 164, 3413-9 (2000)), for peptide chains of anti-bacteria or anti-virus in microbiology (Lavi, T., Siman-Tov, R. & Ankri, S. EhMLBP is an essential constituent of the Entamoeba histolytica epigenetic machinery and a potential drug target. Mol Microbiol 69, 55-66 (2008); Welch, B. D., VanDemark, A. P., Heroux, A., Hill, C. P. & Kay, M. S. Potent D-peptide inhibitors of HIV-1 entry. Proc Natl Acad Sci USA 104, 16828-33 (2007); and, Dharmasena, M. N., Jewell, D. A. & Taylor, R. K. Development of peptide mimics of a protective epitope of Vibrio cholerae Ogawa O-antigen and investigation of the structural basis of peptide mimicry. J Biol Chem 282, 33805-16 (2007)), for specific condensation nuclei in materiology (Ahmad, G. et al. Rapid bioenabled formation of ferroelectric BaTiO₃ at room temperature from an aqueous salt solution at near neutral pH. J Am Chem Soc 130, 4-5 (2008)) and for tumor pathology (Rodi, D. J. et al. Screening of a library of phage-displayed peptides identifies human bcl-2 as a taxol-binding protein. J Mol Biol 285, 197-203 (1999); Jakobsen, C. G., Rasmussen, N., Laenkholm, A. V. & Ditzel, H. J. Phage display derived human monoclonal antibodies isolated by binding to the surface of live primary breast cancer cells recognize GRP-78. Cancer Res 67, 9507-17 (2007); Landon, L. A., Zou, J. & Deutscher, S. L. Is phage display technology on target for developing peptide-based cancer drugs? Curr Drug Discov Technol 1, 113-32 (2004); Tan, C. et al. Identification of a novel small-molecule inhibitor of the hypoxia-inducible factor 1 pathway. Cancer Res 65, 605-12 (2005); and, Landon, L. A. & Deutscher, S. L. Combinatorial discovery of tumor targeting peptides using phage display. J Cell Biochem 90, 509-17 (2003)). For example, early studies have found taxol for inhibiting growth of cancer cells; but, its molecular mechanism of inhibition is not clear. However, researchers (Rodi, D. J. et al. Screening of a library of phage-displayed peptides identifies human bcl-2 as a taxol-binding protein. J Mol Biol 285, 197-203 (1999)) use phage display library for screening out high-affinity amino acid sequences against taxol. Then the sequences screened out are used to search known proteins in NCBI. At last, Bcl-2 is confirmed to be the protein binding with taxol. Taxol is bound to Bcl-2 in cell for killing cancer cells. Besides, many researchers use phage display library to find peptides having specific binding to labeled tumor cells (Landon, L. A. & Deutscher, S. L. Combinatorial discovery of tumor targeting peptides using phage display. J Cell Biochem 90, 509-17 (2003)). Such as, consistency of the binding protein for av intergrin is target RGD, consistency of the binding protein for fibroblast growth factor receptor (FGFR) is MQLPLAT; etc.

Because phage antigen display system has high affinity for high-throughput screening, it is widely used as a tool. The system is mainly used for studying protein interactions. Some others used the technology to search high-affinity peptide ligands capable of specific binding to tumor biomarker.

However, although some reports (Dong, D. et al. Vascular targeting and antiangiogenesis agents induce drug resistance effector GRP-78 within the tumor microenvironment. Cancer Res 65, 5785-91 (2005); Lee, A. S. GRP-78 induction in cancer: therapeutic and prognostic implications. Cancer Res 67, 3496-9 (2007); and, Dong, D. et al. Critical role of the stress chaperone GRP-78/BiP in tumor proliferation, survival, and tumor angiogenesis in transgene-induced mammary tumor development. Cancer Res 68, 498-505 (2008)) reveal that a protein, GRP-78, is greatly expressed in cancer cells, function of the protein on cell membrane is still not clear. Hence, the prior arts do not fulfill all users' requests on actual use.

### SUMMARY OF THE INVENTION

The main purpose of the present invention is to provide high-affinity peptides against a tumor biomarker, GRP-78, and a screening method thereof.

To achieve the above purpose, the present invention are high-affinity peptide probes against tumor biomarker, GRP-78, and a screening method thereof, where the high-affinity peptide probes have five peptides of amino acid sequences of YSLRMDF, KVW, KLWVIPQ, KCCY and HLHYALP; and the screening method thereof comprises steps of: (a) fixing a target protein at bottom of a container to be added with a plurality of phages; (b) binding each phage to the target protein by using amino acid sequences contained in the phage; (c) obtaining a TBST buffer having Tween-20 to process washing; (d) eluting the phages under a weak acid status to be collected; (e) after amplifying the collected phages, running a panning process of binding, washing and eluting as in step (b) to step (d) for two times; (f) running a quantification process with the screened phages and processing DNA sequencing with the phages; and (g) processing enzyme-linked immunosorbent assay (ELISA) analysis to the phages to obtain high-affinity peptides of amino acid sequences of YSLRMDF, KVW, KLWVIPQ, KCCY and HLHYALP.

Accordingly, novel high-affinity peptide probes against tumor biomarker, GRP-78, and a screening method thereof are obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the flow view showing the screening process of the preferred embodiment according to the present invention;

FIG. 2 is the view showing the ELISA analysis;

FIG. 3 is the view showing the phages obtained after several times of the panning process;

FIG. 4 is the view showing the calculating process of the ELISA analysis;

FIG. 5 is the view showing the result of the ELISA analysis; and

FIG. 6 and FIG. 7 are the views of the phage and the quantification process.

### DESCRIPTION OF THE PREFERRED EMBODIMENT(S)

The following description of the preferred embodiment is provided to understand the features and the structures of the present invention.

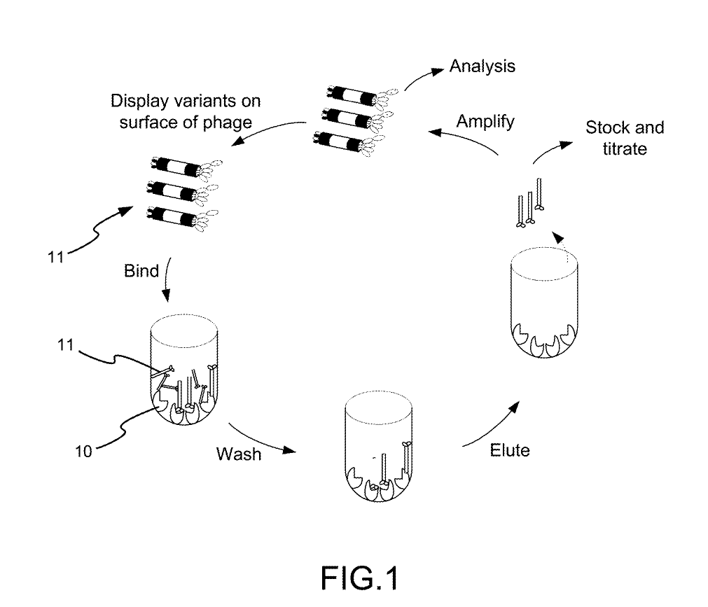

Please refer to FIG. 1 to FIG. 3, which are a flow view showing a screening process of a preferred embodiment according to the present invention; a view showing an ELISA analysis; and a view showing phages obtained after several times of a panning process. As shown in the figures, the present invention are high-affinity peptide probes against tumor biomarker, GRP(glucose-regulated protein)-78, and a screening method thereof, where phage display is used for affinity screening. In FIG. 1, a method of screening high-affinity peptides comprises the following steps:

(a) A desired target protein 10 is fixed at bottom of a container added with selected phages 11 from phage display library.

(b) Each phage 11 is bound to the target protein 10 by using amino acid sequences contained in the phage 11.

(c) A TBST buffer having 0.1% Tween-20 is obtained for processing washing. By using Tween-20 as a surfactant, unspecific bindings are destroyed.

(d) The phages 11 which are bound to the target protein 10 are eluted under a weak acid status to be collected.

(e) after amplifying the collected phages 11 bound to the target protein 10, a panning process of binding, washing and eluting as in step (b) to step (d) is run for two times. For better screening efficiency, a density of Tween-20 is increased after each time of the panning process. It is because that the unspecific bindings are not destroyed with a too low density of Tween-20; yet a too high density of Tween-20 not only destroys the specific bindings between the phages 11 and the target protein 10 but also destroys integrities of proteins in the phages 11. Hence, in the present invention, the density of Tween-20 is gradually increased from 0.1% to 0.3% and to 0.5%, at last.

(f) Then, a quantification process is run with the screened phages 11 for estimating screening efficiency. DNA sequencing is then processed with the phages 11 to obtain actual sequences of 7 amino acids deposed on g3 protein (g3p).

(g) In the end, enzyme-linked immunosorbent assay (ELISA) analysis is processed with the phages 11 to obtain high-affinity amino acid sequences of peptides.

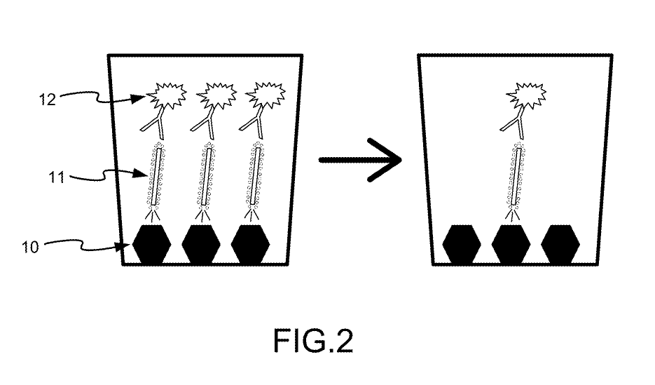

In FIG. 2, after three times of the panning process, luminescent antibodies 12 (HRP-conjugated M13-phage g8p monoclone antibody) against the phages 11 are added to be washed with the TBST buffer having 0.5% Tween-20. At last, an enhanced chemiluminescence (ECL) substrate is added for developing. As shown in FIG. 2, fewer phages 11 with a weaker luminescence are left after washing with the TBST buffer.

Therein, if the panning process is run fewer times, consensus sequences are hard to be obtained and affinities become not uniform. In the other hand, because the 7 amino acids at outside will affect binding forces between g3p and bacterial pilus, the binding forces between g3p and bacterial pilus is increased following the increase in times of running the panning process. In such a situation, a bigger variety in number of the phages 11 is caused by amplifying the phages 11 and too many times of panning will affect infection of the phages 11, which will not guarantee best affinity. Hence, the preferred times for running the panning process are three.

On using the present invention, GRP-78 is used as a target protein. After purifying GRP-78, amino acid sequences having binding forces are filtered out to be used as a probe. The present invention uses the probe to search known protein sequences for estimating binding proteins of GRP-78; and, the probe can be labeled through a radioactive light or with a luminescent material for detecting tumor.

After the first time of panning, the phages obtained are quite few. But, following the increasing times of running the panning process, the number of the eluted phages is increased. By comparing 100 blue plaques in a LB culture plate, the number of the eluted phages is found to be increased about 10 times, which means 10 times of affinity is obtained after each panning process.

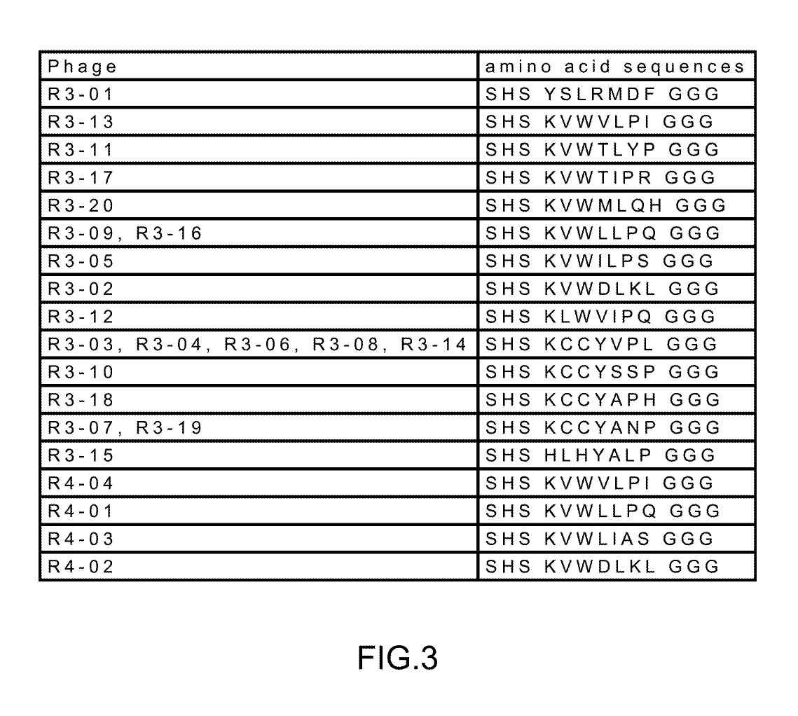

After three times of panning, 20 obviously independent phages are picked out for DNA sequencing and the 7 amino acid sequences carried at N-terminus of g3p are analyzed according to a result of the DNA sequencing. Besides, it is also tried to analyze the phages obtained after four times of panning; and 24 obviously independent phages are picked out. In FIG. 3, R3's are the phages obtained after three times of panning and R4's are the phages obtained after four times of panning; and, SHS and GGG are the original sequences of the phages. After a preliminary analysis, these 24 amino acid sequences comprises 5 main sequences: YSLRMDF, KVW, KLWVIPQ, KCCY and HLHYALP. However, YSLRMDF and KLWVIPQ have very few occurrences, which may mean that their affinities are not so good. In addition, KLWVIPQ is very similar to KVW. It is because that leucine and valine are both branched-chain amino acids with similar physical and chemical characertistics; and four amino acids ‘LWVI’ are hydrophobic amino acids, which may become hydrophobic to Maxisorb and so is not specifically bound. Thus, KLWVIPQ is ruled out for later analysis.

After four times of panning, there are four phages and all of them contain KVW, which may mean KVW are peptide ligands having strong and powerful affinity. Nevertheless, it may still only mean differences on infection of the phages.

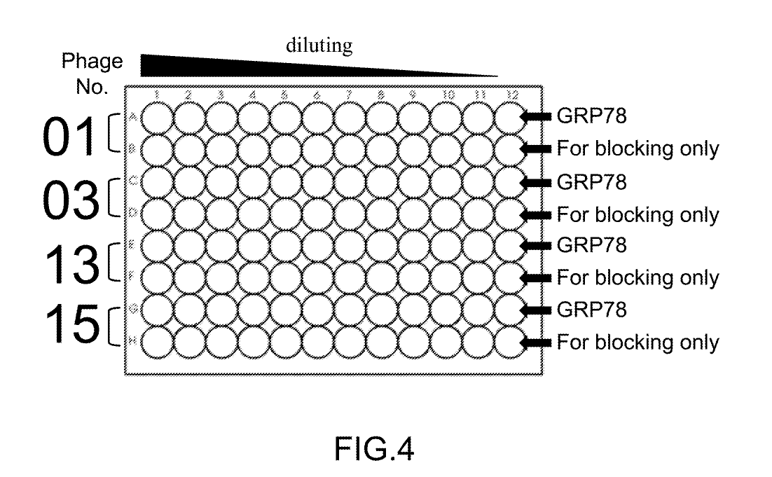

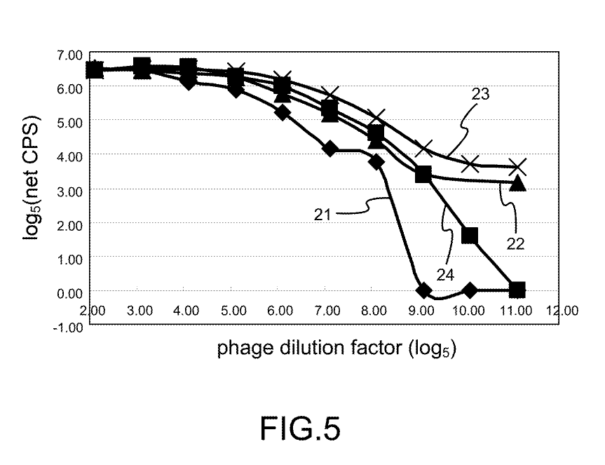

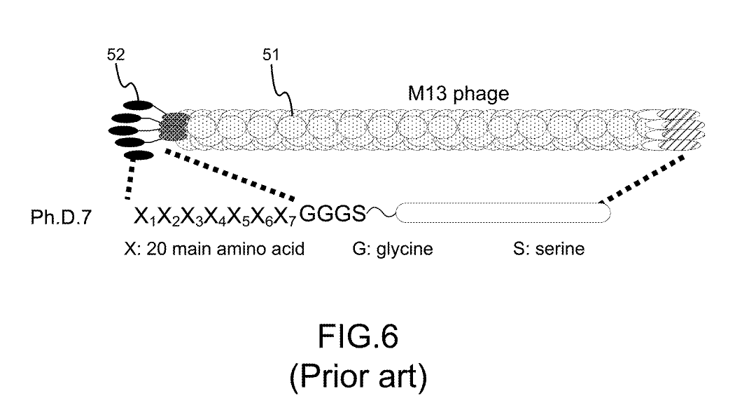

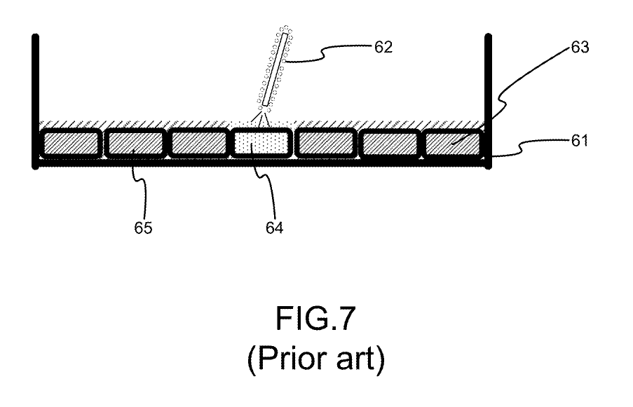

Please further refer to FIG. 4 and FIG. 5, which are a view showing a calculating process and a result of an ELISA analysis. As shown in the figures, the four sequences selected from the five sequences are numbered as phage#01, phage#03, phage#13 and phage#15 for comparing their affinities to GRP-78. An ELISA analysis is processed after values of densities of the phages are deducted by background values at the same densities. In FIG. 3, Maxisorb 96-well plate is used. Row 11 and row 12 are not used. A1˜A10, C1˜C10, E1˜E10 and G1˜G10 are coated with GRP-78. 80 wells of A1˜A10, B1˜B10, C1˜C10, D1˜D10, E1˜E10, F1˜F10, G1˜G10, H1˜H10 and I1˜I10 along with 40 clean wells are all blocked. On diluting the phages, the plate containing the 80 blocked wells along with the 40 blocked clean wells is used. The first to the tenth wells in each row contain phages sequentially diluted. For example, C2 and D2 contain phage#03 having the same density; except that C2 contains the target protein, GRP-78, and D2 does not. A number of counts per second (CPS) is obtained by using an ELISA reader. CPS of C2 is deducted with CPS of D2 to obtain pure CPS.

In FIG. 5, a lateral axis shows phage density after logarithm and a vertical axis shows pure CPS after logarithm. As a result, a curve 21 for phage#01 shows obviously weak affinity; a curve 22 for phage#13 and a curve 23 for phage#15 are very close; and, a curve 24 for phage#03 is located between the curve 21 for phage#01 and the curves 22,23 for phage#13 and phage#15.

Through observing the curve 21 for phage#01, it is found that a phage dilution factor is swiftly dropped down during 58˜9. Moreover, the occurrence of phage#01 is only 1/24, which may show hydrophobicity to Maxisorb. Hence, phage#01 may not be available for further use.

The results of ELISA analyses for phage#13 and phage#15 are very similar; yet, the occurrences of the phages have a big difference in between, which produces sampling error. However, it may mean that these two sequences have the same binding terminal for GRP-78. Although these two both have high binding forces, but the binding force of phage#13 is obviously better than that of phage#15. Hence, further use is mainly based on phage#13.

The binding force of phage#03 is a little weaker than those of phage#13 and phage#15 yet with a higher occurrence of the phage, where its ELISA curve are almost match with what is expected. It means that, following the gradual dilution of the phage, luminescence released becomes weaker; and, so, phage#03 is worthy of further use. On the contrary, when phage#13 and phage#15 are diluted to a dilution factor of 510, luminescence released stops becoming weaker. It may be because that the dilution is not totally completed and the density difference of the phage becomes too small.

Hence, the present invention uses phage display to screen out amino acid sequences of KVW and KCCY, which may have strong binding forces to GRP-78. Further use is to synthesize these two peptides and eliminate interferences from the phages themselves for comparing binding forces of these two peptides to GRP-78. Moreover, these peptides can be selected to be labeled through a radioactive light or with a luminescent material for obtaining probes for the tumor biomarker, GRP-78.

To sum up, the present invention are high-affinity peptide probes against tumor biomarker, GRP-78, and a screening method thereof, where high-affinity peptide ligands are found for a tumor biomarker, GRP-78; affinities of the peptide ligands are compared to evaluate their availability for further use; five amino acid sequences are found and two sequences from the five ones are available for further use; and, since GRP-78 is greatly expressed on surface of tumor cells, these two sequences can be used to find tumor cells having over-expressions for tumor photography.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A plurality of high-affinity peptide ligands against GRP-78,
wherein said peptide ligands comprises amino acid sequences having high affinity of binding to a tumor biomarker, GRP(glucose-regulated protein)-78; and
wherein said amino acid sequences are YSLRMDF, KVW, KLWVIPQ, KCCY and HLHYALP.

2. A probe of tumor biomarker,
wherein said probe has a plurality of peptides having specific binding capacity to a tumor biomarker, GRP-78; and
wherein said peptides comprises amino acid sequences and said amino acid sequences are YSLRMDF, KVW, KLWVIPQ, KCCY and HLHYALP.

3. The probe according to claim 2,
wherein said probe is labeled through a method to detect tumor; and
wherein said method is selected from a group consisting of being labeled with a radioactive material and being labeled with a luminescent material.

4. A method of screening high-affinity peptides, comprising steps of:
(a) fixing a target protein at bottom of a container to be added with a plurality of phages;
(b) binding each one of said phages to said target protein by using amino acid sequences contained in said one of said phages;
(c) obtaining a TBST buffer having Tween-20 to process washing;
(d) eluting said ones of said phages bound to said target protein under a weak acid status to be collected;
(e) after amplifying said collected ones of said phages bound to said target protein, running a panning process of binding, washing and eluting as in step (b) to step (d) for two times;
(f) running a quantification process with said screened ones of said phages and processing DNA sequencing with said ones of said phages;
(g) processing enzyme-linked immunosorbent assay (ELISA) analysis to said ones of said phages to 2obtain high-affinity peptides of amino acid sequences of YSLRMDF, KVW, KLWVIPQ, KCCY and HLHYALP,
wherein said TBST buffer has a 0.1%˜0.5% density of Tween-20 gradually increased after each time of said panning process.

5. The method according to claim 4,
wherein said target protein is GRP-78.

6. The method according to claim 4,
wherein said Tween-20 is a surfactant.

7. The method according to claim 4,
wherein said density of Tween-20 is gradually increased from 0.1% to 0.3% and to 0.5%, at last.

8. The method according to claim 4,
wherein said screened ones of said phages are obtain by screening through phages in phage display library.
